(19) United States
(12) Patent Application Publication
(10) Pub. No.: US 2026/0252565 A1
(43) Pub. Date: Aug. 27, 2026

(54) FINE-GRAINED QUERY PROFILING FOR DATABASE SYSTEMS

(71) Applicant: Crowdstrike, Inc., Sunnyvale, CA (US)

(72) Inventors: Mikkel Milo Tromborg Nielsen, Risskov (DK); Laurits Christensen, Tilst (DK)

(21) Appl. No.: 19/065,874

(22) Filed: Feb. 27, 2025

(51) Int. Cl. G06F 16/2453

(52) U.S. Cl. CPC G06F 16/24549

(57) ABSTRACT

A system and method of a query profiling system that analyzes query performance. The method includes receiving a request to analyze a query associated with a dataset. The method includes analyzing the query to generate a representation indicating a plurality of commands within the query. The method includes generating, based on the representation, a plurality of profile points to analyze a performance of the plurality of commands. The method includes generating, based on the representation, a transformed query including the plurality of commands and the plurality of profile points. The method includes performing, during an execution of the transformed query, a plurality of measurements on the plurality of commands based on the plurality of profile points to generate a performance report including the plurality of measurements.

### TECHNICAL FIELD

The present disclosure relates to data processing, and more particularly, to systems and methods of a fine-grained query profiling system that analyzes query performance for database systems.

### BACKGROUND

Database systems and data warehouses are both important tools for managing and analyzing data. A database system is designed for online transactional processing (OLTP), which involves managing day-to-day operations and transactions. It stores current data and supports simple, fast queries to retrieve specific records. In contrast, a data warehouse is optimized for online analytical processing (OLAP), which involves analyzing large volumes of historical data to support decision-making. Data warehouses aggregate data from multiple sources and use complex queries to identify trends and patterns. While databases focus on quick, efficient transaction processing, data warehouses prioritize query performance for in-depth analysis, often employing techniques like indexing, partitioning, and caching to handle large datasets efficiently.

### BRIEF DESCRIPTION OF THE DRAWINGS

The described embodiments and the advantages thereof may best be understood by reference to the following description taken in conjunction with the accompanying drawings.

These drawings in no way limit any changes in form and detail that may be made to the described embodiments by one skilled in the art without departing from the spirit and scope of the described embodiments.

FIG. 1 is a block diagram depicting an example environment for performing a real-time fine-grained profiling of queries and using the profiling to analyze query performance in the database system, according to some embodiments;

FIG. 2A is a block diagram depicting an example of a real-time fine-grained profiling (RQP) system of the environment in FIG. 1, according to some embodiments;

FIG. 2B is a block diagram depicting an example of a client device in FIG. 1, according to some embodiments;

FIG. 2C is a block diagram depicting an example environment for using the RQP system in FIG. 1, according to some embodiments;

FIG. 3 is a table illustrating profiling statistics for a query, according to some embodiments;

FIG. 4 is a flow diagram depicting a method of performing a real-time fine-grained profiling of queries and using the profiling to analyze query performance in the database system, according to some embodiments; and

FIG. 5 is a block diagram of an example computing device that may perform one or more of the operations described herein, in accordance with some embodiments.

### DETAILED DESCRIPTION

Given a query in an index-free database system or log management system, identifying its real-world performance, especially identifying performance bottlenecks, can be difficult. Especially for larger queries over complex datasets, knowing which part of a several hundred line query is causing the performance bottleneck can help knowing where to optimize when needed, instead of guessing.

Currently, the best available tool is A/B testing on a query, which involves running different variants of the query and comparing their execution speeds. However, this method offers only limited insight into the query's overall performance.

Efficient queries use fewer resources, allowing for more concurrent queries on the same hardware or optimizing cost with existing hardware. Additionally, better-optimized queries result in faster responses, which can be critical in security systems that build incident and response mechanisms on top of queries.

Centralized log management systems allow organizations to efficiently store, analyze, and retain massive volumes of log and event data, making it easier to detect and respond to security threats in real time (as they happen), rather than after the threat has already caused harm to the computing systems in the computing environment. Although these systems include a work metric that gives a holistic view of the query performance, they do not provide the user with granular information. Consequently, attempts to optimize a query using the conventional log management system requires extensive trial and error, including commenting out lines and multiple reruns of the query.

Furthermore, external measurements of a query execution can include data pertaining to the query execution as a black box environment, such as measuring the execution time or memory usage of the entire query. However, this also only provides a holistic and thus very limited view of the query's performance characteristics. Thus, there is a long-felt but unsolved need for a solution that is intrinsic to the system (e.g., query compiler, optimizer) that can inspect the internals of the query and report a detailed, step-by-step breakdown of the different parts of the query, in order to fully understand where and how to optimize the query.

Aspects of the present disclosure address the above-noted and other deficiencies by providing a real-time fine-grained query profiling (RQP) system that analyzes query performance for database systems. The RQP system runs the query in a “debug” mode that outputs a performance report including an execution time (a summation of time spent executing that command) for each command (e.g., step, instruction, operation) in the query and a total count of events processed at each command. That is, the RQP system searches the data as the query normally would, but outputs a performance report of the performance findings instead of the normal query output. A user may then use the performance report to make performance optimization decisions for the query.

The RQP system inserts hidden profiling points between different points of interest within the query. During query execution, the runtime environment then performs measurements at each profiling point on each processed event, computing relevant profiling statistics across profiling points, and reports live updating of profiling statistics to the user as the query executes. The implementation is made as a command that will change the mode of running the query, but in some embodiments, could be implemented as an auxiliary input to the query similar to the search interval.

In an illustrative embodiment, a real-time fine-grained query profiling (RQP) system that analyzes query performance for database systems. The RQP system receives a request to analyze a query associated with a dataset. The RQP system analyzes the query to generate a representation that indicates a hierarchical structure of a plurality of commands within the query. The RQP system generates, based on the representation, a plurality of profile points configured to analyze a real-time performance of the plurality of commands. The RQP system generates, based on the representation, a transformed query including the plurality of commands and the plurality of profile points. The RQP system performs, during an execution of the transformed query, a plurality of measurements on the plurality of commands based on the plurality of profile points to generate a performance report including the plurality of measurements.

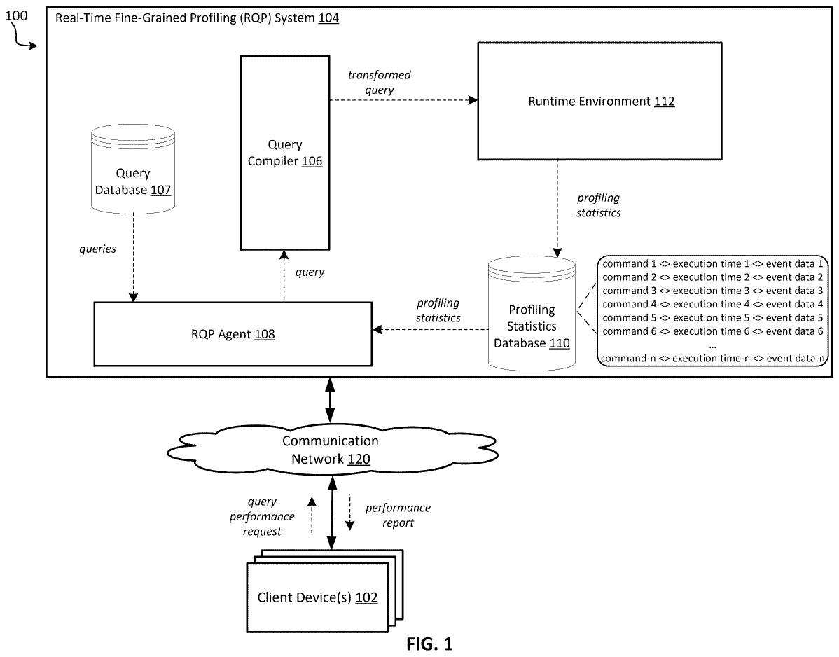

FIG. 1 is a block diagram depicting an example environment for performing a real-time fine-grained profiling of queries and using the profiling to analyze query performance in the database system, according to some embodiments. Environment 100 includes a real-time fine-grained profiling (RQP) system 104 and client devices 102 that are each communicably coupled together via a communication network 120. The RQP system 104 includes a query compiler 106, an ROP agent 108, and a runtime environment 112.

The RQP system 104 includes a plurality of databases that are configured to store different datasets. Specifically, the RQP system 104 includes a query database 107 that is configured to store a plurality of queries. A query is a specific request for data from a data storage, such as a data warehouse, data stores, data marts, data lakes, databases, and or the like. A query includes instructions for retrieving, updating, and/or manipulating data based on certain criteria.

The RQP system 104 also includes a profiling statistics database 110 that is configured to store a mapping between a plurality of profiling points, a plurality of query commands, a plurality of execution times, and a plurality of event datasets. For example, command 1 of a query may include “rename (foo, as=bar)” and command 2 of the query may include “rename (foo, as=baz)”. Therefore, event data 2 indicates the total number of events processed by the previous command (e.g., command 1) and execution time 2 indicates how long the previous command took to produce its output.

In some embodiments, each of the components (e.g., query compiler 106, RQP agent 108, runtime environment 112) of the RQP system 104 may be housed into a single computing device (e.g., a server, a laptop, a desktop, a host device, etc.). However, in other embodiments, some or all of the components of the RQP system 104 may be included in separate computing device and/or database that are geographically/physically separate from one another, but communicatively coupled via the communication network 120. Similarly, each of the databases (e.g., query database 107, profiling statistics database 110) may correspond to its own separate database that is geographically/physically separate from the servers and other databases, but communicatively coupled via the communication network 120.

The communication network 120 may be a public network (e.g., the internet), a private network (e.g., a local area network (LAN) or wide area network (WAN), or a combination thereof. In one embodiment, communication network 120 may include a wired or a wireless infrastructure, which may be provided by one or more wireless communications systems, such as Wi-Fi® connectivity to the communication network 120 and/or a wireless carrier system that can be implemented using various data processing equipment, communication towers (e.g., cell towers), etc. The communication network 120 may carry communications (e.g., data, message, packets, frames, etc.) between any other the computing device.

The RQP system 104 and client device 102 may each be any suitable type of computing device or machine that has a processing device, for example, a server computer (e.g., an application server, a catalog server, a communications server, a computing server, a database server, a file server, a game server, a mail server, a media server, a proxy server, a virtual server, a web server), a desktop computer, a laptop computer, a tablet computer, a mobile device, a smartphone, a set-top box, a graphics processing unit (GPU), etc. In some examples, a computing device may include a single machine or may include multiple interconnected machines (e.g., multiple servers configured in a cluster).

A computing device may be one or more virtual environments. In one embodiment, a virtual environment may be a virtual machine (VM) that may execute on a hypervisor which executes on top of an operating system (OS) for a computing device. The hypervisor may manage system sources (including access to hardware devices, such as processing devices, memories, storage devices). The hypervisor may also emulate the hardware (or other physical resources) which may be used by the VMs to execute software/applications. In another embodiment, a virtual environment may be a container that may execute on a container engine which executes on top of the OS for a computing device. For example, a container engine may allow different containers to share the OS of a computing device (e.g., the OS kernel, binaries, libraries, etc.). A computing device may use the same type or different types of virtual environments. For example, all of the computing devices may be VMs. In another example, all of the computing devices may be containers. In a further example, some of the computing devices may be VMs, other computing device may be containers, and other computing devices may be computing devices (or groups of computing devices).

Still referring to FIG. 1, the RQP agent 108 receives a request (shown in FIG. 1 as query performance request) from a client 102, where the request is to analyze a query associated with a dataset and/or database schema. The request may include the query itself or an identifier (e.g., network path, query name, file path, and/or the like) to the query. The RQP agent 108 may use the identifier to the query to retrieve the query from the query database 107 if the query is not included in the request. The RQP agent 108 then sends the query to the query compiler 106.

The query compiler 106 analyzing the query to generate a representation that indicates a hierarchical structure of a plurality of commands (e.g., a memory read command, a memory write command, a rename command, a count command) included in the query. The query compiler 106 generates, based on the representation, a plurality of profile points that are respectively associated with the plurality of commands of the query. Each profile point is configured to analyze a real-time performance of its associated command. For example, a first profile point may be configured to measure a first set of measurements associated with a first command (e.g., rename(foo, as=bar)) and a second profile point may be configured to measure a second set of measurements associated with a second command (e.g., rename(foo, as=baz)).

The RQP agent 108 generates, based on the representation, a transformed query that includes the plurality of commands and the plurality of profile points. The RQP agent 108 sends the transformed query to the runtime environment 112, which includes all the software (e.g., software libraries, operating system) and hardware components to execute the transformed query. During the execution of the transformed query, the runtime environment 112 performs a plurality of measurements on the plurality of commands at the plurality of profile points and stores the plurality of measurements in the profiling statistics database 110 to be assessable to the RQP agent 108. Alternatively, in other embodiments, the runtime environment 112 may directly send the profiling statistics to the RQP agent 108, allowing the RQP agent 108 to bypass retrieving the profiling statistics from the profiling statistics database 110. The RQP agent 108 generates a performance report that includes the plurality of measurements, thereby indicating the one or more bottlenecks of the query. In some embodiments, the runtime environment 112 may generate the performance report instead of the RQP agent 108. The RQP agent 108 sends the performance report to the client device 102, allowing the user of the client device 102 to optimize the query based on the performance report.

Although FIG. 1 shows only a select number of computing devices (e.g., RQP system 104, client devices 102); the environment 100 may include any number of computing devices that are interconnected in any arrangement to facilitate the exchange of data between the computing devices.

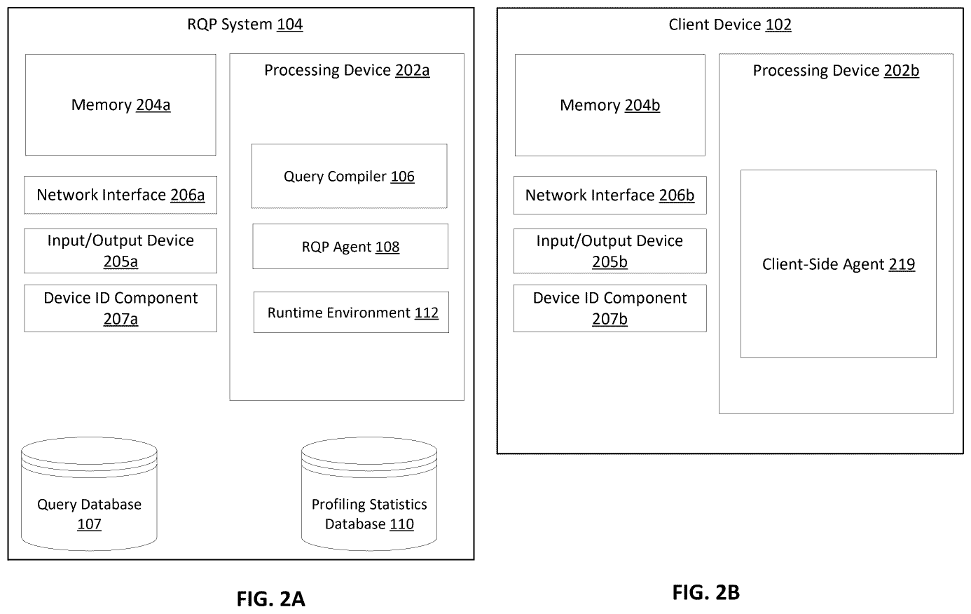

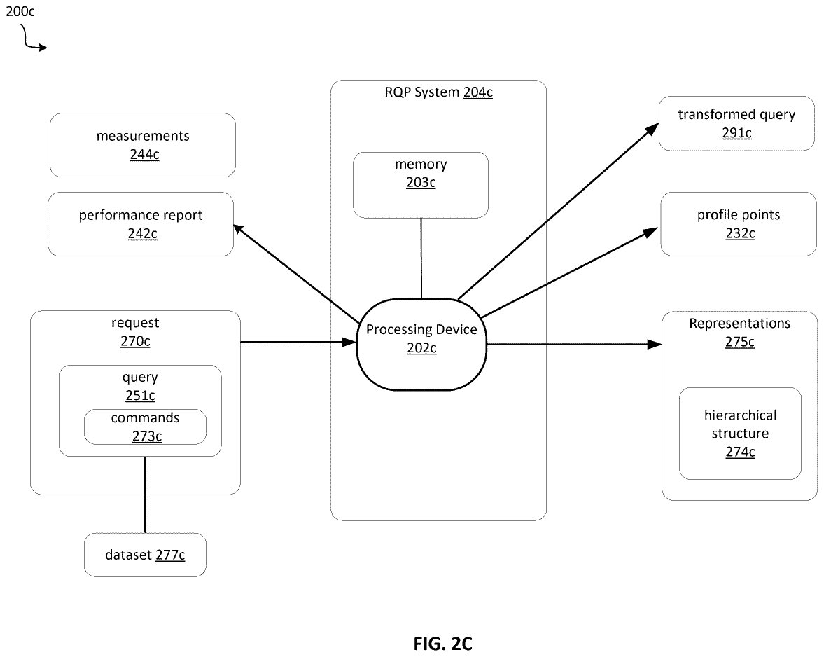

FIG. 2A is a block diagram depicting an example of a real-time fine-grained profiling (RQP) system of the environment in FIG. 1, according to some embodiments. While various devices, interfaces, and logic with particular functionality are shown, it should be understood that the RQP system 104 includes any number of devices and/or components, interfaces, and logic for facilitating the functions described herein. For example, the activities of multiple devices may be combined as a single device and implemented on a same processing device (e.g., processing device 202a), as additional devices and/or components with additional functionality are included.

The RQP system 104 includes a query database 107 that is configured to store a plurality of queries. A query is a specific request for data from a data storage, such as a data warehouse, data stores, data marts, data lakes, databases, and or the like. A query includes instructions for retrieving, updating, and/or manipulating data based on certain criteria. The RQP system 104 also includes a profiling statistics database that is configured to store a mapping between a plurality of query commands, a plurality of execution times, and a plurality of event datasets.

The RQP system 104 includes a processing device 202a (e.g., general purpose processor, a PLD, etc.), which may be composed of one or more processors, and a memory 204a (e.g., synchronous dynamic random-access memory (DRAM), read-only memory (ROM)), which may communicate with each other via a bus (not shown).

The processing device 202a may be provided by one or more general-purpose processing devices such as a microprocessor, central processing unit, or the like. In some embodiments, processing device 202a may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 202a may include one or more special-purpose processing devices such as an application specific integrated circuit (ASIC), a field programmable gate array (FPGA), a digital signal processor (DSP), network processor, or the like. The processing device 202a may be configured to execute the operations described herein, in accordance with one or more aspects of the present disclosure, for performing the operations and steps discussed herein.

The memory 204a (e.g., Random Access Memory (RAM), Read-Only Memory (ROM), Non-volatile RAM (NVRAM), Flash Memory, hard disk storage, optical media, etc.) of processing device 202a stores data and/or computer instructions/code for facilitating at least some of the various processes described herein. The memory 204a includes tangible, non-transient volatile memory, or non-volatile memory. The memory 204a stores programming logic (e.g., instructions/code) that, when executed by the processing device 202a, controls the operations of the RQP system 104. In some embodiments, the processing device 202a and the memory 204a form various processing devices and/or circuits described with respect to the RQP system 104. The instructions include code from any suitable computer programming language such as, but not limited to, C, C++, C#, Java, JavaScript, VBScript, Perl, HTML, XML, Python, TCL, and Basic.

The processing device 202a includes and/or executes a query compiler 106, an ROP agent 108, and a runtime environment 112. The RQP agent 108 receives a request to analyze a query associated with a dataset and sends the request to the query compiler 106. The query compiler 106 analyzes the query to generate a representation that indicates a hierarchical structure of a plurality of commands within the query. In some embodiments, the query compiler 106 analyzes the query while the query is not executing.

The query compiler 106 generates, based on the representation, a plurality of profile points configured to analyze a real-time performance of the plurality of commands. In some embodiments, the query compiler 106 generate the plurality of profile points while the query is not executing. The query compiler 106 generates, based on the representation, a transformed query comprising the plurality of commands and the plurality of profile points. The runtime environment 112 performs, during an execution of the transformed query, a plurality of measurements on the plurality of commands based on the plurality of profile points to generate a performance report comprising the plurality of measurements.

In some embodiments, the query compiler 106 generates, based on the representation, the transformed query by configuring a first profile point of the plurality of profile points to include a first set of instructions dedicated to monitoring a first command of the plurality of commands; and configuring a second profile point of the plurality of profile points to include a second set of instructions dedicated to monitoring a second command of the plurality of commands.

In some embodiments, the query compiler 106 inserts the first profile point of the plurality of profile points between the first command and the second command. In some embodiments, the query compiler 106 inserts the second profile point of the plurality of profile points after the first command and the second command and before a third command of the plurality of commands.

In some embodiments, the runtime environment 112 performs, during the execution of the transformed query, the plurality of measurements by calculating, based on the first profile point, a size of a first output generated by the first command; and/or calculating, based on the second profile point, a size of a second output generated by the second command.

In some embodiments, the runtime environment 112 performs, during the execution of the transformed query, the plurality of measurements by calculating, based on the first profile point, a time for the first command to generate a first output; and/or calculating, based on the second profile point, a time for the second command to generate a second output.

In some embodiments, the runtime environment 112 performs, during the execution of the transformed query, the plurality of measurements by sending the transformed query to a distributed database to cause the distributed database to execute the transformed query.

In some embodiments, the RQP agent 108 sends the performance report to a client device 102 to cause the performance report to display on a screen of the client device 102. The performance report indicates one or more performance bottlenecks within the query.

In some embodiments, the RQP agent 108 receives, responsive to sending the performance report to the client device 102, an optimized version of the query from the client device 102.

The RQP system 104 includes a network interface 206a configured to establish a communication session with a computing device for sending and receiving data over the communication network 120 to the computing device. Accordingly, the network interface 206a includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some embodiments, the RQP system 104 includes a plurality of network interfaces 206a of different types, allowing for connections to a variety of networks, such as local area networks (public or private) or wide area networks including the Internet, via different sub-networks.

The RQP system 104 includes an input/output device 205a configured to receive user input from and provide information to a user. In this regard, the input/output device 205a is structured to exchange data, communications, instructions, etc. with an input/output component of the RQP system 104. Accordingly, input/output device 205a may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.).

The one or more user interfaces may be internal to the housing of the RQP system 104, such as a built-in display, touch screen, microphone, etc., or external to the housing of RQP system 104, such as a monitor connected to RQP system 104, a speaker connected to RQP system 104, etc., according to various embodiments. In some embodiments, The RQP system 104 includes communication circuitry for facilitating the exchange of data, values, messages, and the like between the input/output device 205a and the components of the RQP system 104. In some embodiments, the input/output device 205a includes machine-readable media for facilitating the exchange of information between the input/output device 205a and the components of the RQP system 104. In still another embodiment, the input/output device 205a includes any combination of hardware components (e.g., a touchscreen), communication circuitry, and machine-readable media.

The RQP system 104 includes a device identification component 207a (shown in FIG. 2A as device ID component 207a) configured to generate and/or manage a device identifier associated with the RQP system 104. The device identifier may include any type and form of identification used to distinguish the RQP system 104 from other computing devices. In some embodiments, to preserve privacy, the device identifier may be cryptographically generated, encrypted, or otherwise obfuscated by any device and/or component of RQP system 104. In some embodiments, the RQP system 104 may include the device identifier in any communication (e.g., performance report, etc.) that the RQP system 104 sends to a computing device.

The RQP system 104 includes a bus (not shown), such as an address/data bus or other communication mechanism for communicating information, which interconnects the devices and/or components of RQP system 104, such as processing device 202a, network interface 206a, input/output device 205a, and device ID component 207a.

In some embodiments, some or all of the devices and/or components of RQP system 104 may be implemented with the processing device 202a. For example, the RQP system 104 may be implemented as a software application stored within the memory 204a and executed by the processing device 202a. Accordingly, such embodiment can be implemented with minimal or no additional hardware costs. In some embodiments, any of these above-recited devices and/or components rely on dedicated hardware specifically configured for performing operations of the devices and/or components.

FIG. 2B is a block diagram depicting an example of a client device in FIG. 1, according to some embodiments. While various devices, interfaces, and logic with particular functionality are shown, it should be understood that the client device 102 includes any number of devices and/or components, interfaces, and logic for facilitating the functions described herein. For example, the activities of multiple devices may be combined as a single device and implemented on a same processing device (e.g., processing device 202b), as additional devices and/or components with additional functionality are included.

The client device 102 includes a processing device 202b (e.g., general purpose processor, a PLD, etc.), which may be composed of one or more processors, and a memory 204b (e.g., synchronous dynamic random-access memory (DRAM), read-only memory (ROM)), which may communicate with each other via a bus (not shown). The processing device 202b includes identical or nearly identical functionality as processing device 202a in FIG. 2A, but with respect to devices and/or components of the client device 102 instead of devices and/or components of the RQP system 104.

The memory 204b of processing device 204b stores data and/or computer instructions/code for facilitating at least some of the various processes described herein. The memory 204b includes identical or nearly identical functionality as memory 204a in FIG. 2A, but with respect to devices and/or components of the client device 102 instead of devices and/or components of the RQP system 104.

The processing device 202b may be configured to execute a client-side agent 219. The client-side agent 219 may be configured to send a request (shown in FIG. 1 as query performance request) to the RQP system 104, where the request is to analyze a query associated with a dataset and/or database schema. The request may include the query itself or an identifier (e.g., network path, query name, file path, and/or the like) to the query. A query is a specific request for data from a data storage, such as a data warehouse, data stores, data marts, data lakes, databases, and or the like. A query includes instructions for retrieving, updating, and/or manipulating data based on certain criteria.

The client-side agent 219 may be configured to receive a performance report from the RQP system 104, wherein the performance report indicates one or more performance bottlenecks within the query. The client-side agent 219 may be configured to display the performance report on a screen or monitor of the client device 102.

The client-side agent 219 may be configured to generate an optimized version of the query based on the performance report and send the optimized version of the query to the RQP system 104. The client-side agent 219 may include the optimized version of the query in a query performance request.

The client device 102 includes a network interface 206b configured to establish a communication session with a computing device for sending and receiving data over a network to the computing device. Accordingly, the network interface 206b includes identical or nearly identical functionality as network interface 206a in FIG. 2A, but with respect to devices and/or components of the client device 102 instead of devices and/or components of the RQP system 104.

The client device 102 includes an input/output device 205b configured to receive user input from and provide information to a user. In this regard, the input/output device 205b is structured to exchange data, communications, instructions, etc. with an input/output component of the client device 102. The input/output device 205b includes identical or nearly identical functionality as input/output device 205a in FIG. 2A, but with respect to devices and/or components of the client device 102 instead of devices and/or components of the RQP system 104.

The client device 102 includes a device identification component 207b (shown in FIG. 2B as device ID component 207b) configured to generate and/or manage a device identifier associated with the client device 102. The device ID component 207b includes identical or nearly identical functionality as device ID component 207a in FIG. 2A, but with respect to devices and/or components of the client device 102 instead of devices and/or components of the RQP system 104.

The client device 102 includes a bus (not shown), such as an address/data bus or other communication mechanism for communicating information, which interconnects the devices and/or components of the client device 102, such as processing device 202b, network interface 206b, input/output device 205b, and device ID component 207b.

In some embodiments, some or all of the devices and/or components of client device 102 may be implemented with the processing device 202b. For example, the client device 102 may be implemented as a software application stored within the memory 204b and executed by the processing device 202b. Accordingly, such embodiment can be implemented with minimal or no additional hardware costs. In some embodiments, any of these above-recited devices and/or components rely on dedicated hardware specifically configured for performing operations of the devices and/or components.

FIG. 2C is a block diagram depicting an example environment for using the RQP system in FIG. 1, according to some embodiments. The system 204c (e.g., RQP system 104 in FIG. 1) includes a memory 203c and a processing device 202c that is operatively coupled to the memory 203c. The processing device 202c is configured to receive a request 270c to analyze a query 251 associated with a dataset 277c. The processing device 202c is configured to analyze the query 251 to generate a representation 275c that indicates a hierarchical structure 274c of a plurality of commands 27c within the query. The processing device 202c is configured to generate, based on the representation 275c, a plurality of profile points 232c configured to analyze a real-time performance of the plurality of commands 273c. The processing device 202c is configured to generate, based on the representation 275c, a transformed query 291c comprising the plurality of commands 272s and the plurality of profile points 232c. The processing device 202c is configured to perform, during an execution of the transformed query 291c, a plurality of measurements 244c on the plurality of commands 273c based on the plurality of profile points 232c to generate a performance report 242c comprising the plurality of measurements 244c.

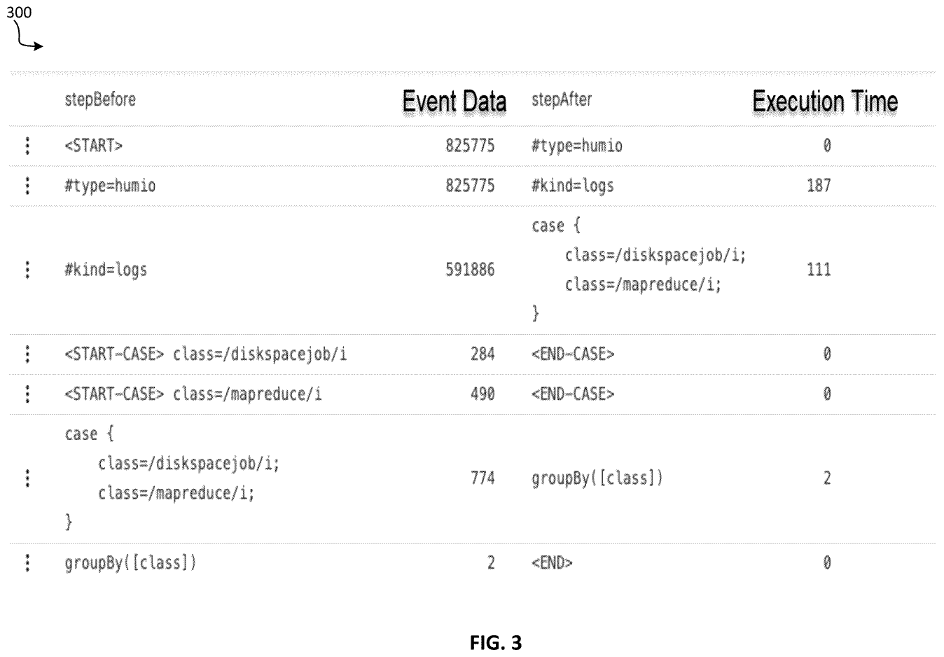

FIG. 3 is a table illustrating profiling statistics for a query, according to some embodiments. The RQP system 104 inserts an internal function between each command of a query allowing the RQP system 104 to collect profiling statistic between each command. The profiling statistics include event data, an execution time, and/or the like. For example, mapping information (e.g., contained in a schema and/or a database) includes a first command (e.g., “rename (foo, as=bar)”) of a query that immediately precedes a second command (“rename (foo, as=baz)”) of the query. The first command is associated with a first set of event data and a first execution time, and the second command is associated with a second set of event data and a second execution time. In this embodiment, the second set of event data indicates the total number of events processed by the first command and the second execution time indicates how long the first command took to produce its output. The RQP system generates the profiling statistics for a query, includes the profiling statistics in a performance report, and sends the performance report to a client device 102 for display on a monitor.

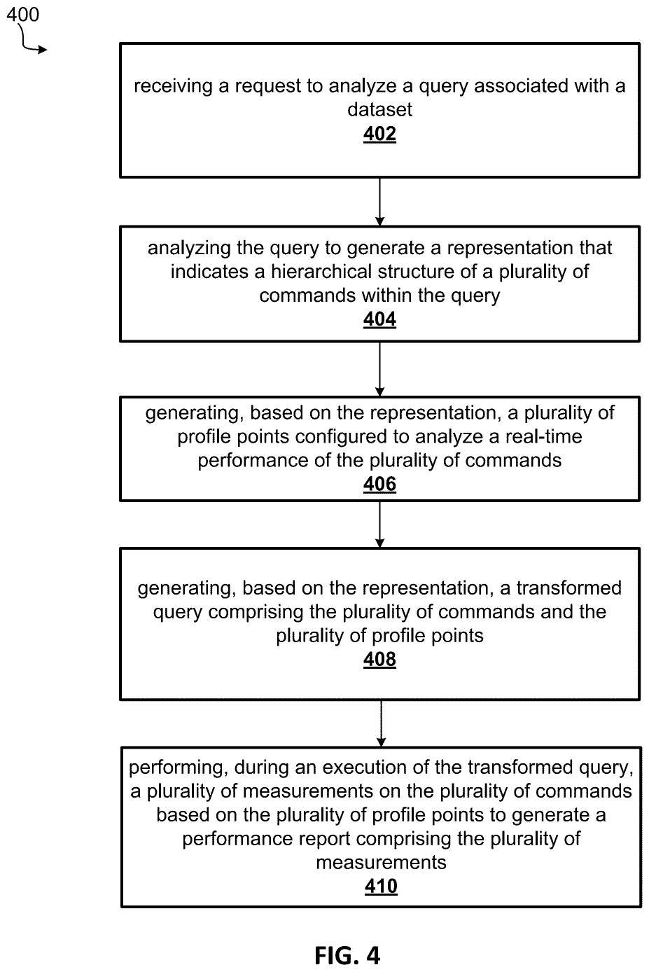

FIG. 4 is a flow diagram depicting a method of performing a real-time fine-grained profiling of queries and using the profiling to analyze query performance in the database system, according to some embodiments. Method 400 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, one or more blocks of method 400 may be performed by one or more real-time fine-grained profiling system, such as RQP system 104 in FIG. 1.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

As shown in FIG. 4, the method 400 includes the block 402 of receiving a request to analyze a query associated with a dataset. The method 400 includes the block 404 of analyzing the query to generate a representation that indicates a hierarchical structure of a plurality of commands within the query. The method 400 includes the block 406 of generating, based on the representation, a plurality of profile points configured to analyze a real-time performance of the plurality of commands. The method 400 includes the block 408 of generating, based on the representation, a transformed query comprising the plurality of commands and the plurality of profile points. The method 400 includes the block 410 of performing, during an execution of the transformed query, a plurality of measurements on the plurality of commands based on the plurality of profile points to generate a performance report comprising the plurality of measurements.

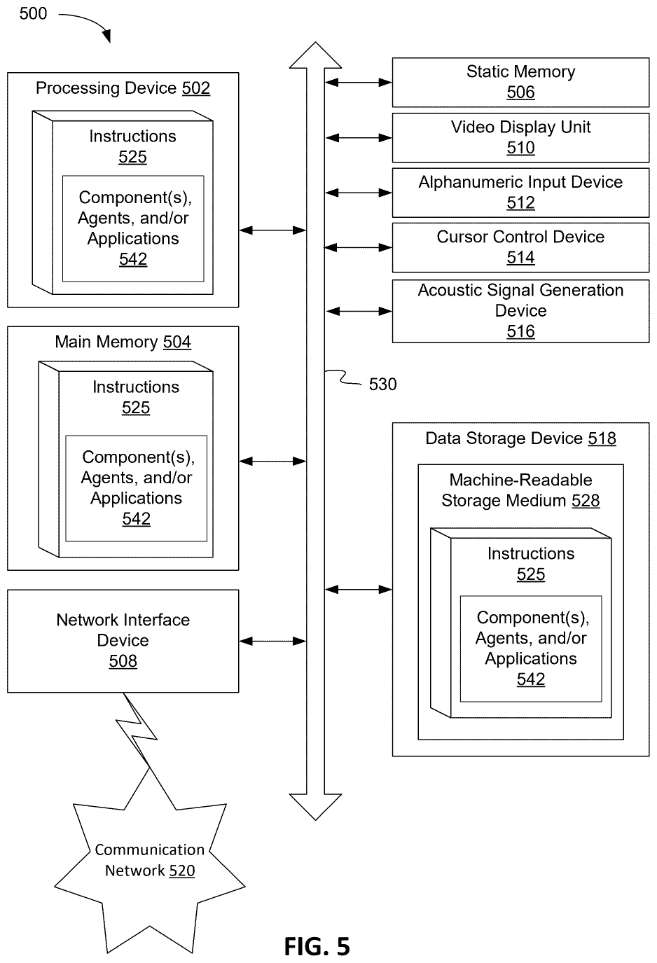

FIG. 5 is a block diagram of an example computing device that may perform one or more of the operations described herein, in accordance with some embodiments. Computing device 500 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 500 may include a processing device (e.g., a general-purpose processor, a PLD, etc.) 502, a main memory 504 (e.g., synchronous dynamic random-access memory (DRAM), read-only memory (ROM)), a static memory 506 (e.g., flash memory and a data storage device 518), which may communicate with each other via a bus 530.

Processing device 502 may be provided by one or more general-purpose processing devices such as a microprocessor, central processing unit, or the like. In an illustrative example, processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 502 may also include one or more special-purpose processing devices such as an application specific integrated circuit (ASIC), a field programmable gate array (FPGA), a digital signal processor (DSP), network processor, or the like. The processing device 502 may be configured to execute the operations described herein, in accordance with one or more aspects of the present disclosure, for performing the operations and steps discussed herein.

Computing device 500 may further include a network interface device 508 which may communicate with a communication network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In one embodiment, video display unit 510, alphanumeric input device 512, and cursor control device 514 may be combined into a single component or device (e.g., an LCD touch screen).

Data storage device 518 may include a computer-readable storage medium 528 on which may be stored one or more sets of instructions 525 that may include instructions for one or more components/programs/applications 542 (e.g., RLA agent 106, threat detection agent 108, AI models 109, evaluator 112, prediction score generator 113 in FIG. 2A, etc.) for carrying out the operations described herein, in accordance with one or more aspects of the present disclosure. Instructions 525 may also reside, completely or at least partially, within main memory 504 and/or within processing device 502 during execution thereof by computing device 500, main memory 504 and processing device 502 also constituting computer-readable media. The instructions 525 may further be transmitted or received over a communication network 520 via network interface device 508.

While computer-readable storage medium 528 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “analyzing,” “generating,” “performing,” “configuring,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112(f), for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present embodiments to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present embodiments are not to be limited to the details given herein, but may be modified within the scope and equivalents of the appended claims.

1. A method of comprising:
receiving a request to analyze a query associated with a dataset;
analyzing the query to generate a representation indicating a plurality of commands within the query;
generating, by a processing device based on the representation, a plurality of profile points configured to analyze a performance of the plurality of commands;
generating, based on the representation, a transformed query comprising the plurality of commands and the plurality of profile points; and
performing, during an execution of the transformed query, a plurality of measurements on the plurality of commands based on the plurality of profile points to generate a performance report comprising the plurality of measurements,
wherein the execution of the transformed query comprises executing the transformed query in a profiling mode that suppresses query result data that would otherwise be returned to a client device in response to execution of the transformed query and, during execution, performs event-level measurements at each profile point that correspond to individual commands of the transformed query.

2. The method of claim 1, wherein analyzing the query occurs while the query is not executing.

3. The method of claim 1, wherein generating the plurality of profile points occurs while the query is not executing.

4. The method of claim 1, wherein generating, based on the representation, the transformed query further comprises:
configuring a first profile point of the plurality of profile points to include a first set of instructions dedicated to monitoring a first command of the plurality of commands; and
configuring a second profile point of the plurality of profile points to include a second set of instructions dedicated to monitoring a second command of the plurality of commands.

5. The method of claim 4, further comprising:
inserting the first profile point of the plurality of profile points between the first command and the second command; and
inserting the second profile point of the plurality of profile points after the first command and the second command and before a third command of the plurality of commands.

6. The method of claim 4, wherein performing, during the execution of the transformed query, the plurality of measurements further comprises:
calculating, based on the first profile point, a size of a first output generated by the first command; and
calculating, based on the second profile point, a size of a second output generated by the second command.

7. The method of claim 4, wherein performing, during the execution of the transformed query, the plurality of measurements further comprises:
calculating, based on the first profile point, a time for the first command to generate a first output; and
calculating, based on the second profile point, a time for the second command to generate a second output.

8. The method of claim 1, wherein performing, during the execution of the transformed query, the plurality of measurements further comprises:
sending the transformed query to a distributed database to cause the distributed database to execute the transformed query.

9. The method of claim 1, further comprising;
sending the performance report to the client device to cause the performance report to display on a screen of the client device, wherein the performance report indicates one or more performance bottlenecks within the query.

10. The method of claim 9, further comprising:
receiving, responsive to sending the performance report to the client device, an optimized version of the query from the client device.

11. A system comprising:
a memory; and
a processing device, operatively coupled to the memory, to:
receive a request to analyze a query associated with a dataset;
analyze the query to generate a representation indicating a plurality of commands within the query;
generate, based on the representation, a plurality of profile points to analyze a performance of the plurality of commands;
generate, based on the representation, a transformed query comprising the plurality of commands and the plurality of profile points; and
perform, during an execution of the transformed query, a plurality of measurements on the plurality of commands based on the plurality of profile points to generate a performance report comprising the plurality of measurements,
wherein the execution of the transformed query comprises executing the transformed query in a profiling mode that suppresses query result data that would otherwise be returned to a client device in response to execution of the transformed query and, during execution, performs event-level measurements at each profile point that correspond to individual commands of the transformed query.

12. The system of claim 11, wherein analyzing the query occurs while the query is not executing.

13. The system of claim 11, wherein generating the plurality of profile points occurs while the query is not executing.

14. The system of claim 11, wherein to generate based on the representation, the transformed query, the processing device is further to:
configure a first profile point of the plurality of profile points to include a first set of instructions dedicated to monitoring a first command of the plurality of commands; and
configure a second profile point of the plurality of profile points to include a second set of instructions dedicated to monitoring a second command of the plurality of commands.

15. The system of claim 14, wherein the processing device is to:
insert the first profile point of the plurality of profile points between the first command and the second command; and
insert the second profile point of the plurality of profile points after the first command and the second command and before a third command of the plurality of commands.

16. The system of claim 14, wherein to perform during the execution of the transformed query, the plurality of measurements, the processing device is further to:
calculate, based on the first profile point, a size of a first output generated by the first command; and
calculate, based on the second profile point, a size of a second output generated by the second command.

17. The system of claim 14, wherein to perform during the execution of the transformed query, the plurality of measurements, the processing device is further to:
calculate, based on the first profile point, a time for the first command to generate a first output; and
calculate, based on the second profile point, a time for the second command to generate a second output.

18. The system of claim 11, wherein to perform during the execution of the transformed query, the plurality of measurements, the processing device is further to:
send the transformed query to a distributed database to cause the distributed database to execute the transformed query.

19. The system of claim 11, further comprising;
sending the performance report to the client device to cause the performance report to display on a screen of the client device, wherein the performance report indicates one or more performance bottlenecks within the query.

20. A non-transitory computer-readable medium storing instructions that, when executed by a processing device, cause the processing device to:
receive a request to analyze a query associated with a dataset;
analyze the query to generate a representation indicating a plurality of commands within the query;
generate, by the processing device based on the representation, a plurality of profile points to analyze a performance of the plurality of commands;
generate, based on the representation, a transformed query comprising the plurality of commands and the plurality of profile points; and
perform, during an execution of the transformed query, a plurality of measurements on the plurality of commands based on the plurality of profile points to generate a performance report comprising the plurality of measurements,
wherein the execution of the transformed query comprises executing the transformed query in a profiling mode that suppresses query result data that would otherwise be returned to a client device in response to execution of the transformed query and, during execution, performs event-level measurements at each profile point that correspond to individual commands of the transformed query.
